(19) United States
(12) Patent Application Publication
(10) Pub. No.: US 2006/0155566 A1
(43) Pub. Date: Jul. 13, 2006

(54) Internet dating system and method

(76) Inventor: Jacqueline Mary Berger, Redhead (AU)

Correspondence Address: JONES DAY, 222 EAST 41ST ST, NEW YORK, NY, 10017, US

(21) Appl. No.: 11/258,284

(22) Filed: Oct. 24, 2005

(30) Foreign Application Priority Data
Oct. 22, 2004 (AU) AU 2004100887 A4

(51) Int. Cl. G06Q 99/00

(52) U.S. Cl. 705/1

(57) ABSTRACT

An Internet dating system and method that systematically documents and stores evaluations by participants of their dating experiences. Each evaluation is then sent, by, for example, email and or SMS, to the other participant in the date. Advantageously, the system processes each evaluation to determine a date rating and prompts the participants to take further action based on that rating.

### BACKGROUND AND SUMMARY

A review of existing Internet dating sites reveals a need for a site that provides an easy to use, automated date feedback mechanism by which each date participant can evaluate the other participant. Such evaluations would be useful not only to the participants themselves, but to other people who might be interested in dating one of the participants.

The present invention addresses this need by providing such an automated date feedback mechanism. Briefly, a date participant evaluates the other participant by completing an automated, on-line questionnaire. The Internet dating system in accordance with the present invention processes the questionnaire and determines a date rating and sends the rating to the other participant to the date by, for example, email or short message service (SMS). The evaluations and ratings may also be stored in a database for later review by the participants and/or other interested people. Advantageously, the system may also prompt the participants to take further action based on that rating. For example, if a participant rates a date positively, the system may prompt the participant to send a gift, such as flowers or candy, to the other participant, send a message to the other participant, or provide suggestions to that participant for another date. A participant receiving a positive rating may be likewise prompted by the system.

In another aspect of the present invention, the system enables a participant to authorize other members of the Internet website system to view his or her date evaluation. In that way, other members may consider that evaluation in deciding whether to arrange a date with the reviewed participant.

In yet another aspect of the present invention, the system may be linked to an established Internet dating website to provide that website with the features described herein.

In still a further aspect of the present invention, the system may be accessed, and evaluations provided and received, via a mobile device, such as a mobile phone. In that way, participants can conveniently provide and receive evaluations of the date while the date is still fresh in their minds.

### BRIEF DESCRIPTION OF THE DRAWINGS

Additional objects and features of the invention will be more readily apparent from the following detailed description and appended claims when taken in conjunction with the drawings, in which:

FIG. 1 is an illustration of a system in accordance with the present invention;

FIG. 2 is an illustration of an alternative embodiment of a system in accordance with the present invention;

FIG. 3 is a block diagram illustrating a process in accordance with the present invention;

FIGS. 4-18 illustrate web pages that may be displayed on a user's computer during the course of the process illustrated in FIG. 3;

FIG. 19 is a block diagram illustrating a process in accordance with the present invention in which a mobile device, such as a cell phone, is used to access the Internet dating system;

FIGS. 20-30 illustrate pages that may be displayed on a user's mobile device during the course of the process illustrated in FIG. 19; and

FIGS. 31-36 illustrate pages that may be displayed on a user's mobile device during the course of sending a pre-written message provided by a system in accordance with the present invention.

In the drawings, like reference numerals refer to like items.

### DETAILED DESCRIPTION

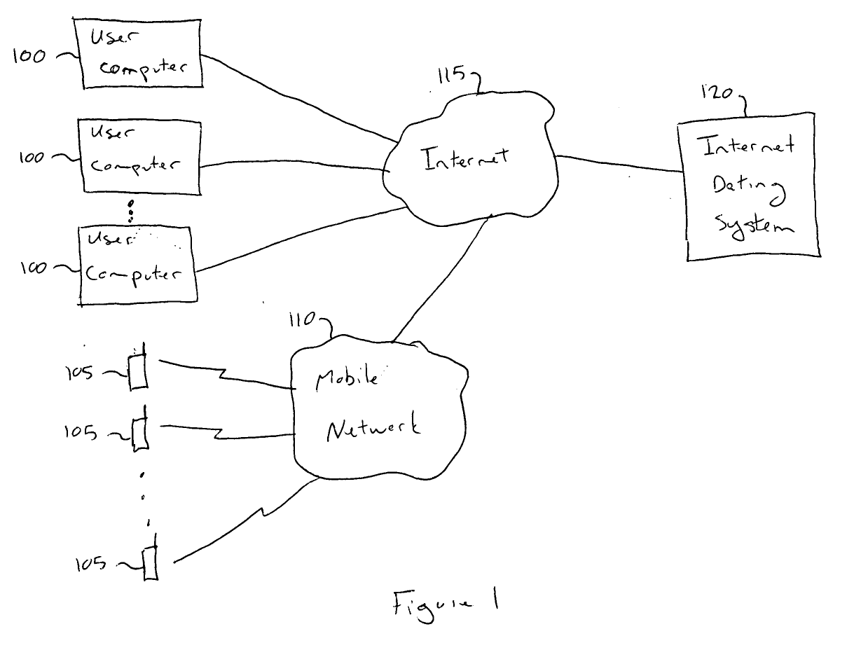

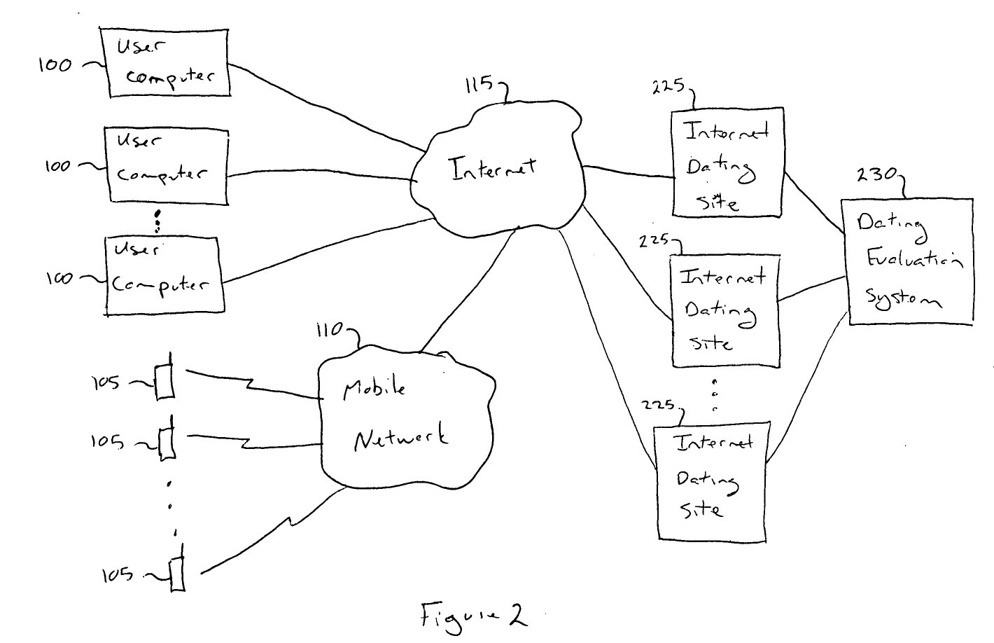

FIG. 1 illustrates an exemplary system in accordance with the present invention, in which one or more user computers 100, such as personal computers, laptop computers, etc., or mobile devices 105, such as mobile phones, personal digital assistants, etc., are capable of communicating with Internet dating system 120, via a network 115, such as the Internet. In the case of mobile devices 105, communication with Internet dating system 120 may also utilize a mobile network 110 that is capable of communicating information over network 115. Internet dating system 120 includes servers and other computers and processors, as well as storage devices, and all other hardware and software necessary for hosting an Internet website, as is known in the art. The Internet dating system 120 further includes a database system for storing information about users of the system, including account information and the evaluations and ratings described below.

FIG. 2 illustrates an alternative exemplary system in accordance with the present invention. In this embodiment, one or more user computers 100, such as personal computers, laptop computers, etc., or mobile devices 105, such as mobile phones, personal digital assistants, etc., are capable of communicating with one or more Internet dating sites 225, via a network 115, such as the Internet, and, in the case of mobile devices 105, mobile network 110. The one or more Internet data sites 225 are, in turn, linked to dating evaluation system 230. Again, Internet dating sites 225 and dating evaluation system 230 include servers and other computers and processors, as well as storage devices, and all other hardware and software necessary for hosting an Internet website and/or communicating with a hosted website, as is known in the art. Dating evaluation system 230 further includes a database system for storing information about users of the system, including account information and the evaluations and ratings described below. In this embodiment, dating evaluation system 230 can act as a central repository for evaluation information that may be shared by some or all of the Internet dating sites 225. In this way, a user that is a member of more than one Internet dating site 225 can have his or her dating information aggregated.

In operation, the features and information provided by dating evaluation system 230 may be incorporated into the web pages served by the one or more Internet dating sites 225, for example, in a separate frame in the web pages served by those sites. Alternatively, the features and information provided by dating evaluation system 230 may be provided in a separate browser window. In either case, a link and/or button may be provided by Internet dating sites 225 that enable the user to access the features provided by dating evaluation system 230.

In both the FIG. 1 and FIG. 2 embodiments, the database stores a history of all date reviews received by each user. The system in turn performs analysis of that information. For example, the database may track the number of dates a user went on, the number of positive and negative responses that were received, and the number of times a user received the same response to the same question. Advantageously, the system may then use that information to provide suggestions to a user for improving his or her dating habits. For example, if a number of reviewers have indicated that the user does not look like the picture that he or she posted on the dating site, the system may send a message to the user, suggesting that he or she change the picture. Similarly, for example, if a number of reviewers have indicated that the user's personality does not match his or her profile, the system may advise the user to change the profile. The system may also use the analyzed information to refer the user to dating materials that specifically address the user's dating deficiencies. The analyzed information may optionally be presented to the user in tabular or graphical form.

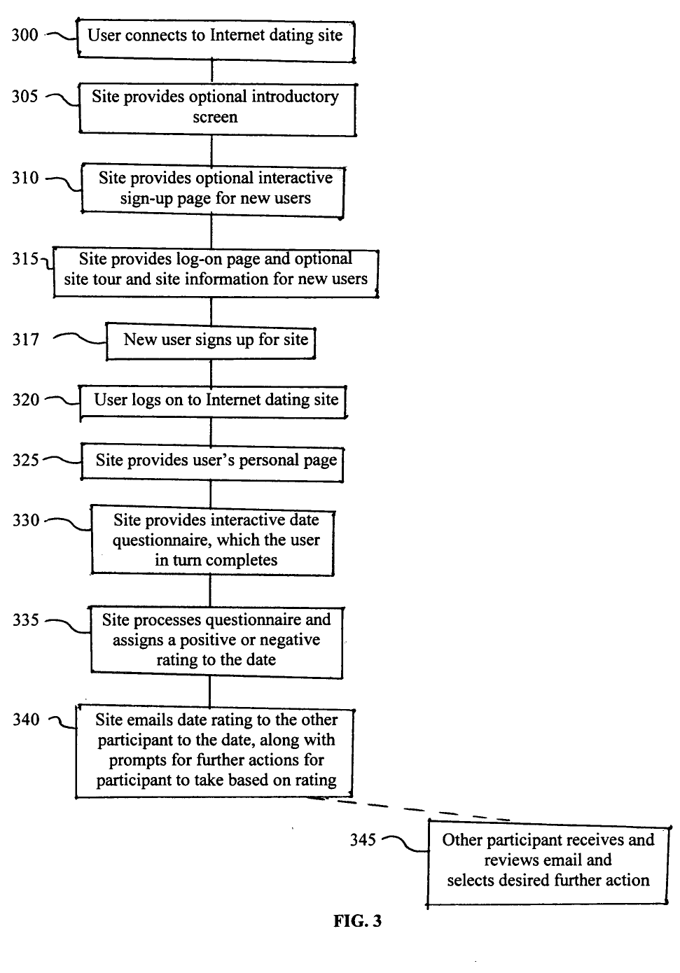

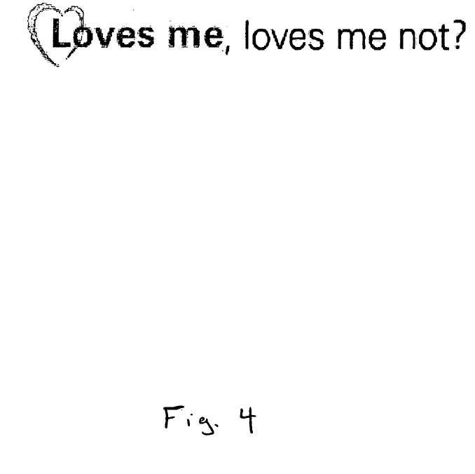

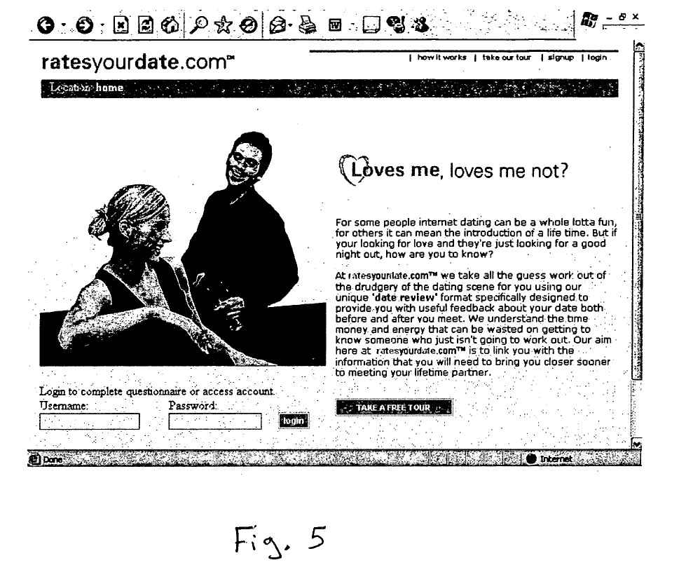

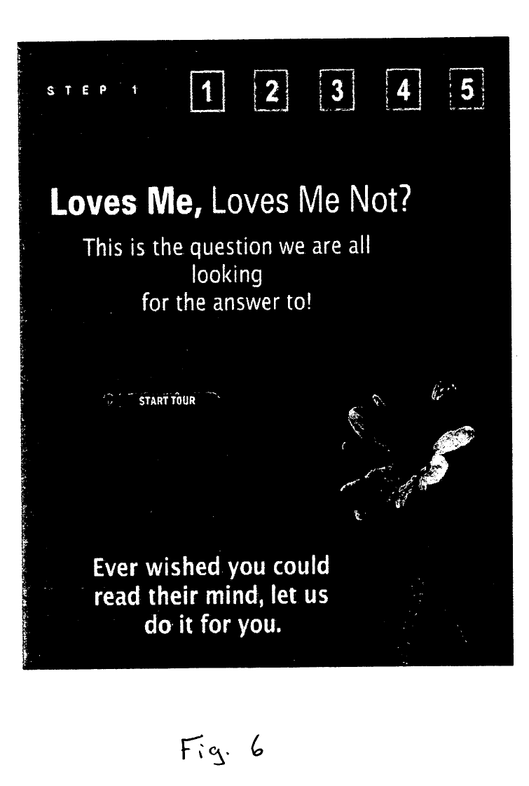

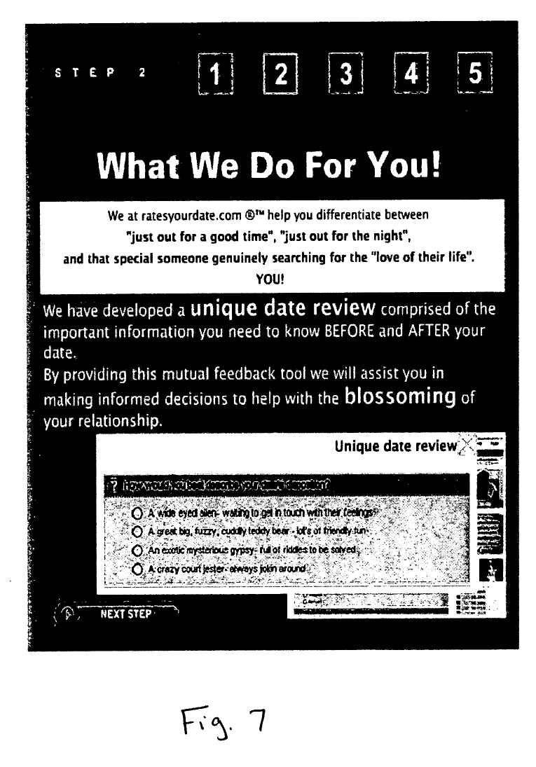

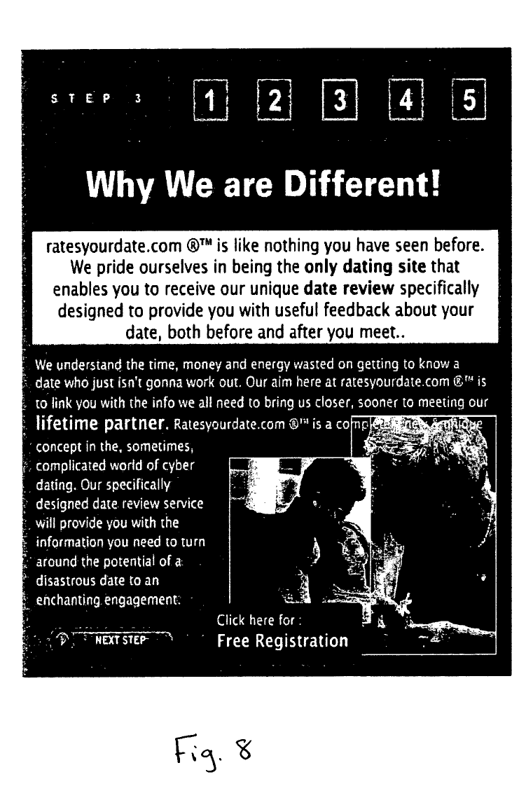

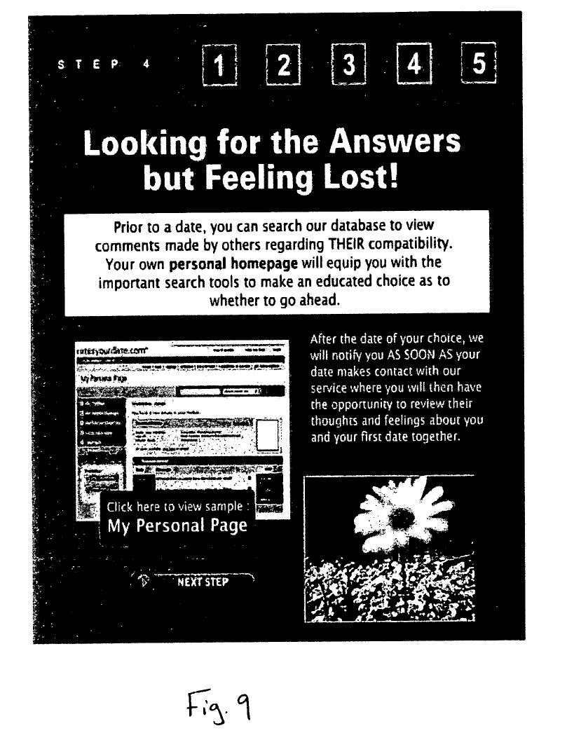

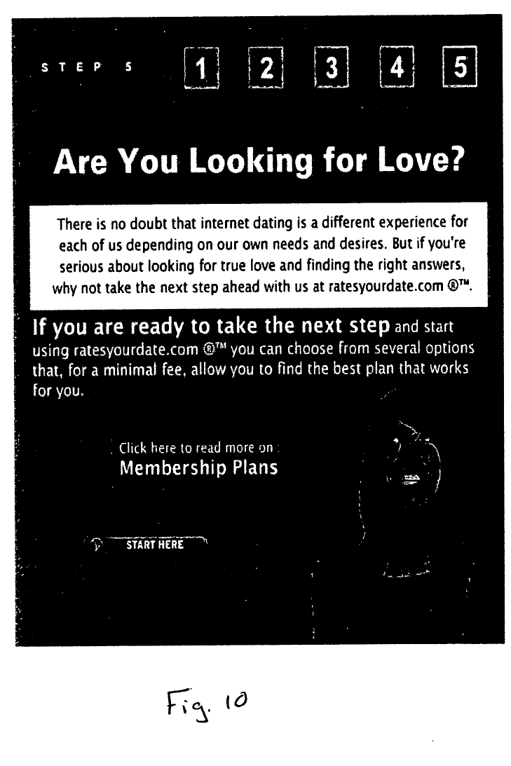

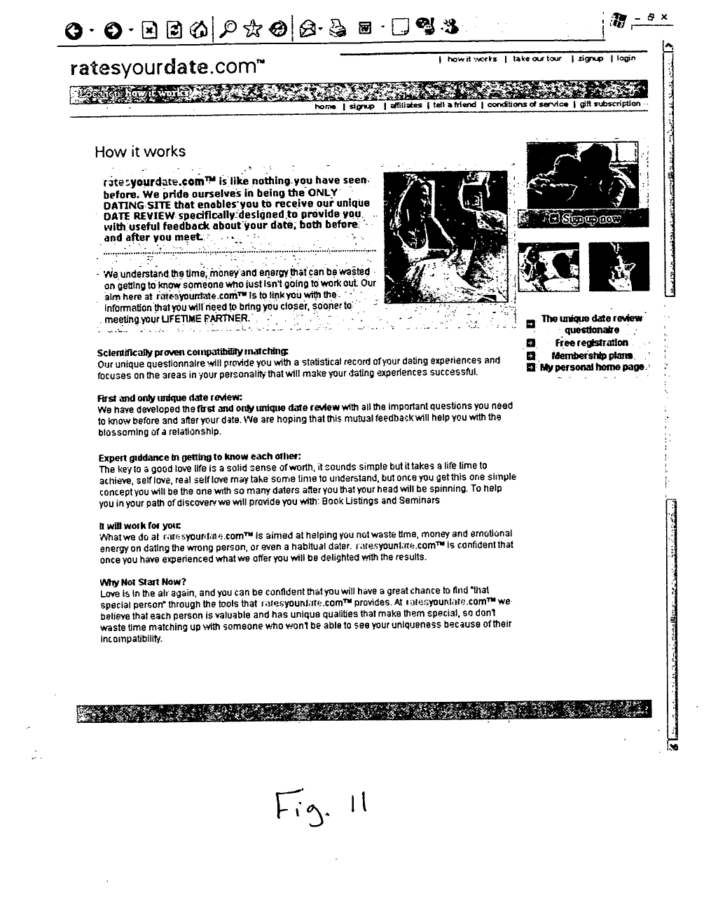

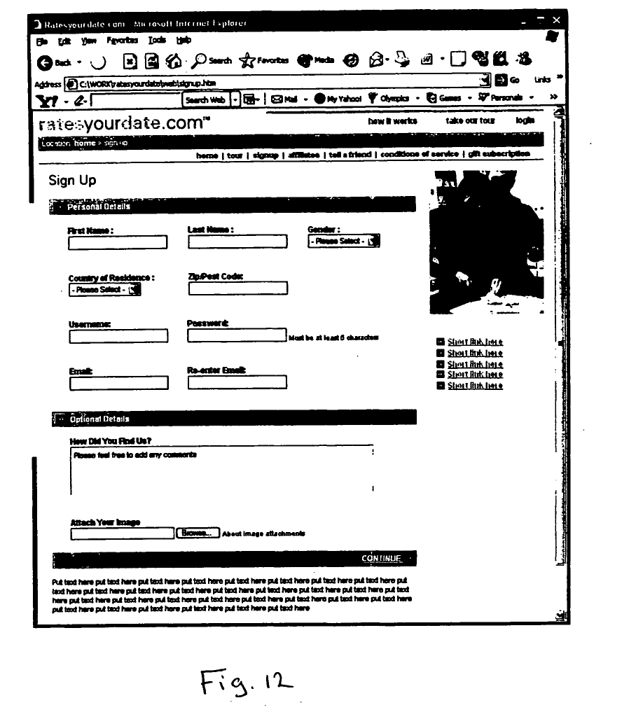

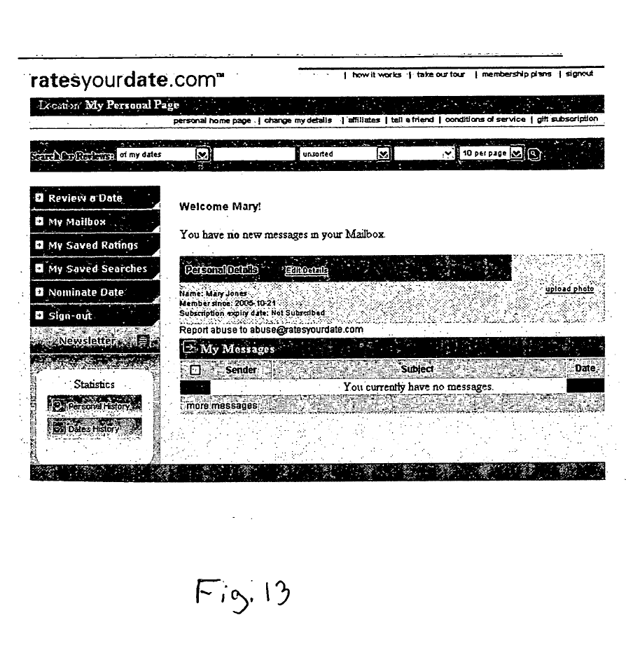

FIG. 3 illustrates an exemplary process, in accordance with the present invention, for providing and utilizing an automated evaluation and rating system in an Internet dating site. The process can be performed by a stand-alone Internet dating system, as shown in FIG. 1, or a combined system comprising one or more Internet dating sites and a dating evaluation system, as shown in FIG. 2. In step 300, a user connects to the system by, for example, entering the URL for the system's web site, or the URL for one of the one or more Internet dating sites shown in FIG. 2, into an Internet browser or selecting a hyperlink, button, or bookmark for the site. In step 305, the site then may optionally provide an introductory screen, such as the one shown in FIG. 4, which is in turn displayed on the screen of the user's computer. In step 310, the site then provides a log-on page, such as the one shown in FIG. 5. In step 315, the log-on page may optionally include a link to a site tour and/or other information about the site that would be useful to a new user. An exemplary site tour for the site is shown in FIGS. 6-10. An example of additional information that may be provided to new users is shown in FIG. 11. In step 317, a new user may sign-up to become a member of the site, in which case the site will provide a sign-up form for the user to complete. An example of a sign-up form is shown in FIG. 12.

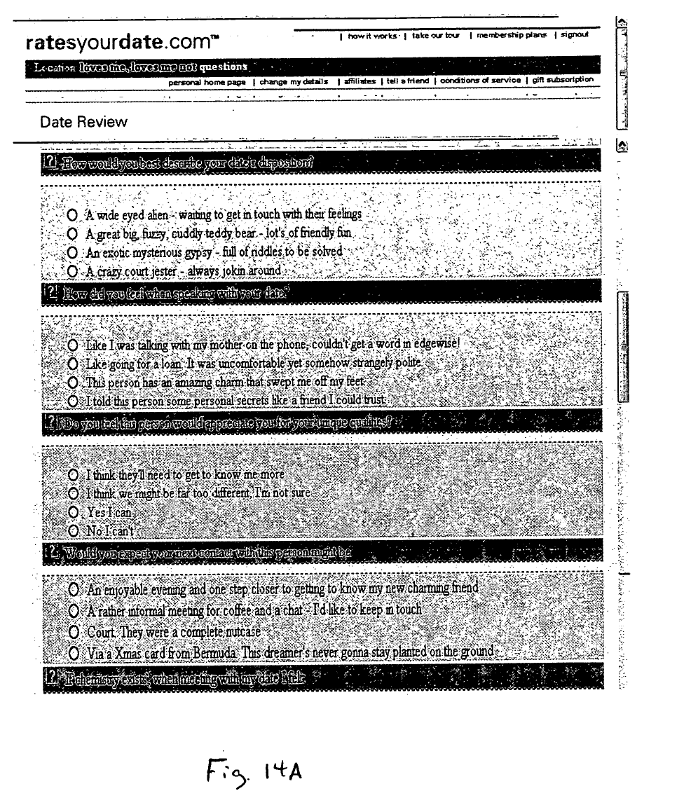

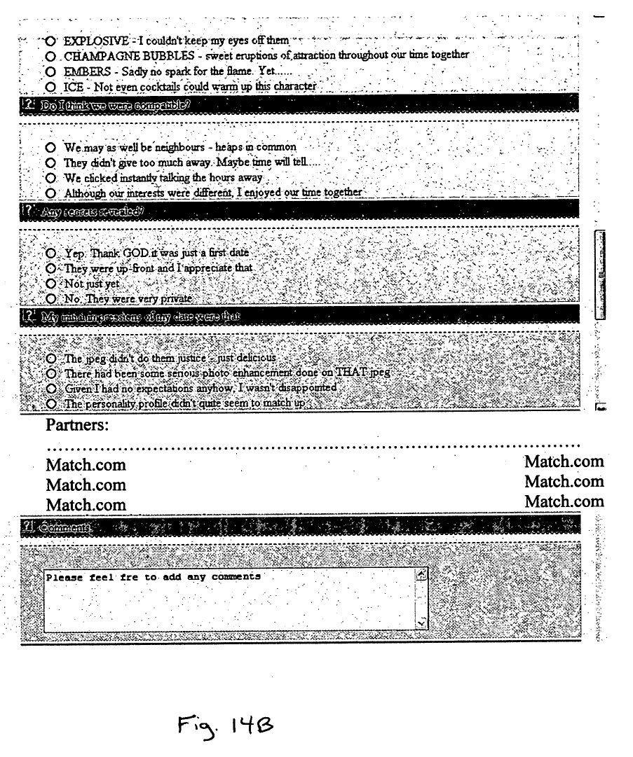

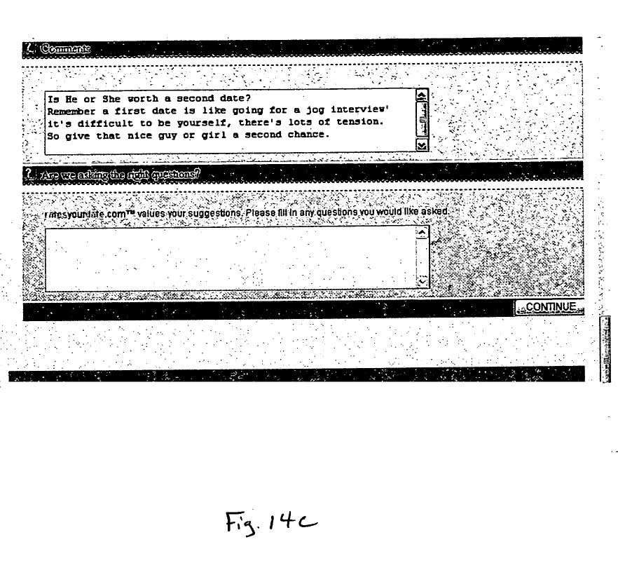

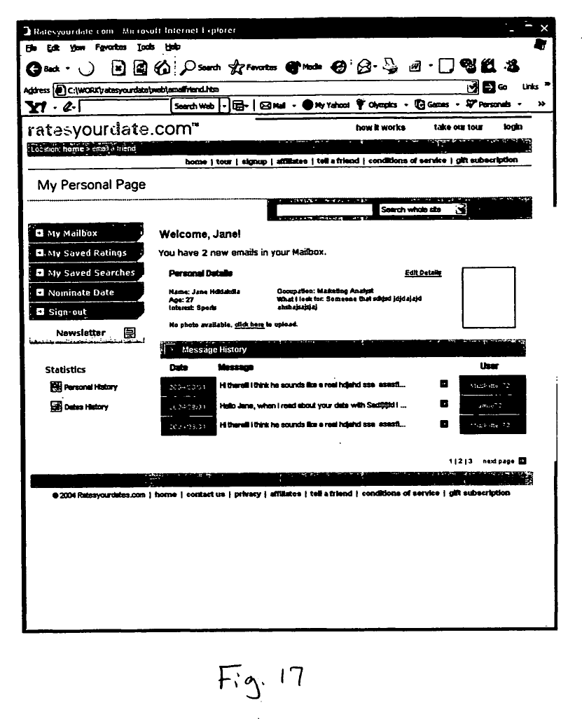

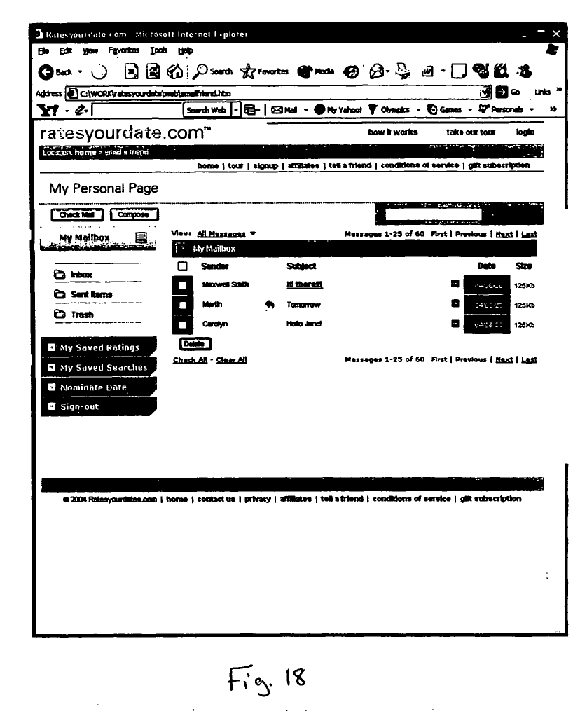

In step 320, the user logs on to the Internet dating site, and, in step 325, the user's personal page is displayed. Exemplary personal pages are shown in FIGS. 13 and 17. FIG. 18 illustrates the display of the user's mailbox, which can be reached through the user's personal page by selecting the My Mailbox button. In step 330, if the user indicates that he or she would like to review a date, the site will provide an interactive date questionnaire for the user to complete. The user can make that indication by, for example, clicking on the Review a Date button shown in FIG. 13. An exemplary date questionnaire is shown in FIGS. 14A-14C.

After the user completes the questionnaire, the site, in step 335, processes the questionnaire and assigns a positive or negative rating to the date.

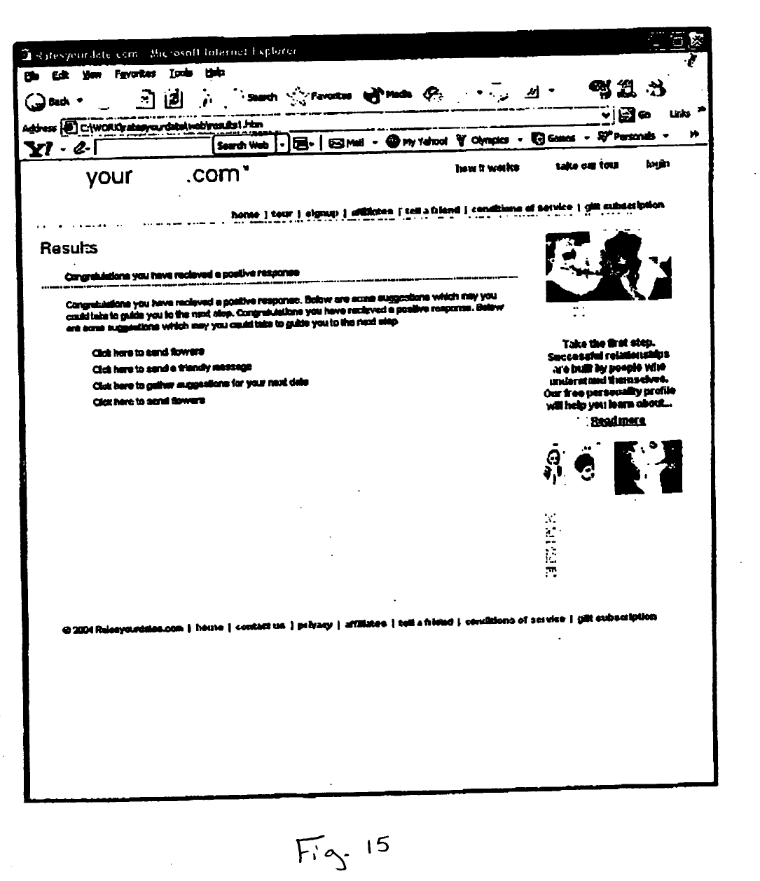

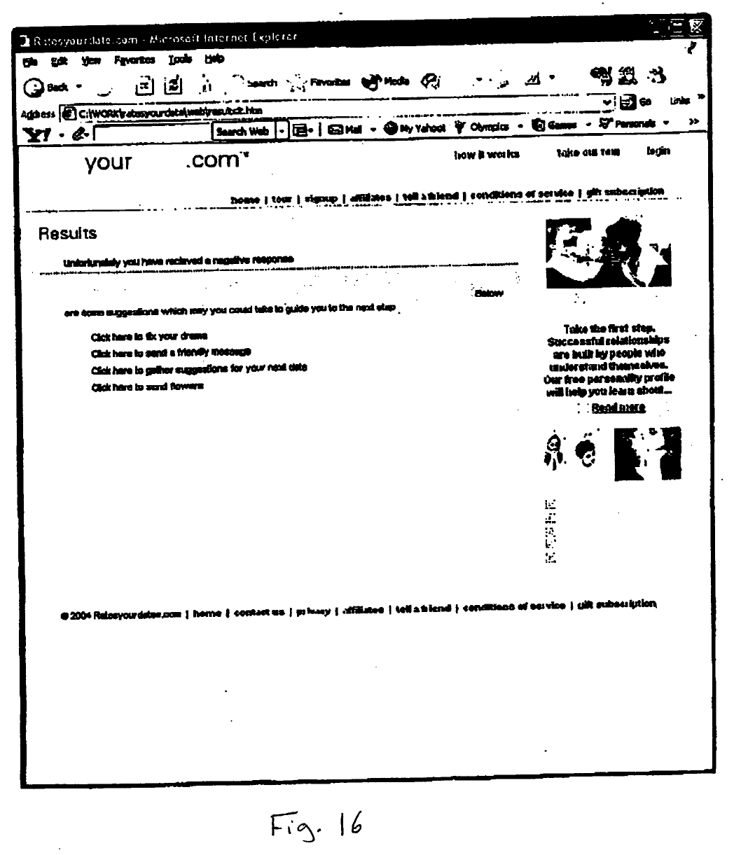

In step 340, the site emails the date rating to the other participant. The email may contain prompts or links that enable further actions for the other participant to take based on the rating. For example, as shown in FIG. 15, if the rating is positive, the email may contain prompts or links for sending the reviewer (i.e., the user who filled out the questionnaire) a gift, such as flowers, sending the reviewer a friendly message, or for gathering suggestions for a next date. As shown in FIG. 16, if the rating is negative, the email may contain a prompt or link for the other participant to “fix your drama,” which will direct the other participant to information that may improve his or her dating skills.

In step 345, the other participant receives and reviews the email containing the date rating. The other participant may then select one of the suggestions for further actions by, for example, clicking on or otherwise selecting one of the prompts or links in the email. By making a selection, the participant may, for example, be directed to a webpage at which flowers may be purchased, provided with a screen for sending a friendly message to the reviewer, provided with suggestions for a next date, or, if the review was negative, provided with helpful dating hints or directed to a dating website to continue the search for a compatible date.

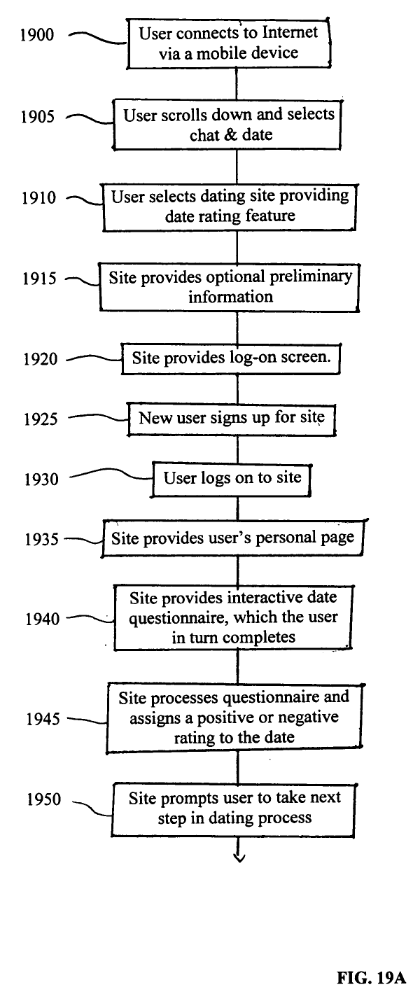

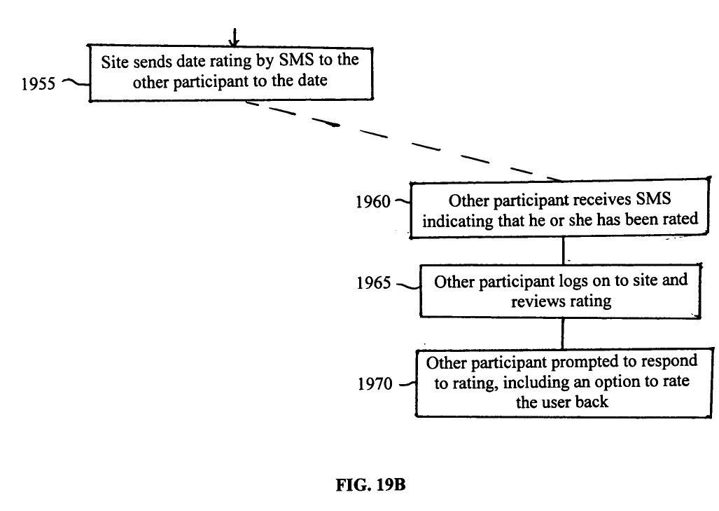

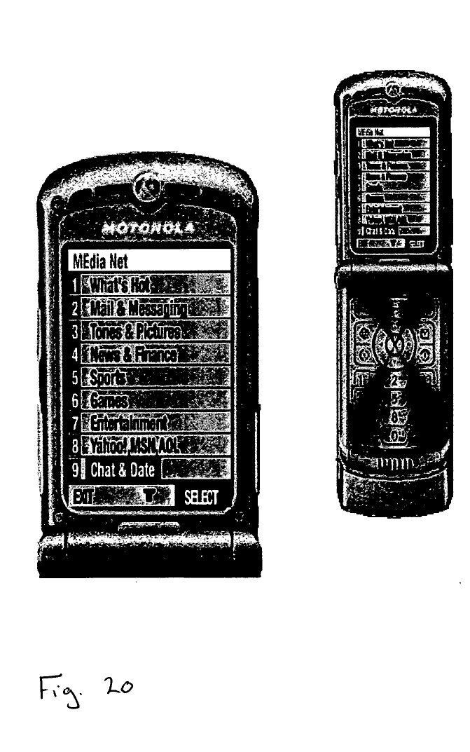

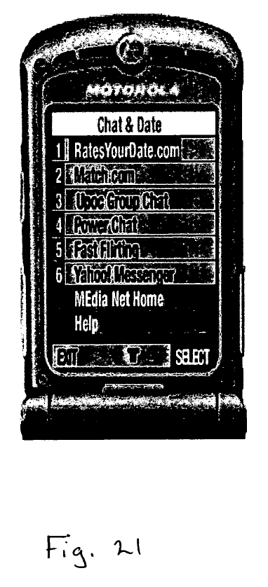

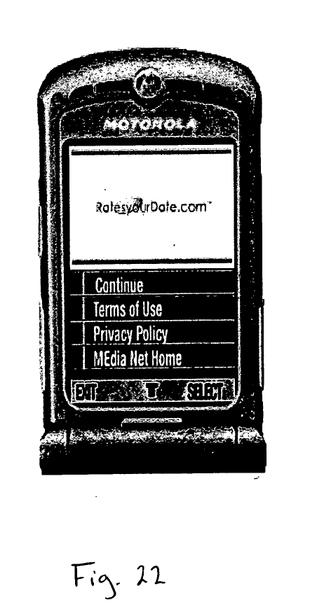

FIG. 19 illustrates an exemplary process, in accordance with the present invention, in which a mobile device, such as a cell phone, is used to access the Internet dating system. In step 1900, a user connects to the Internet via a mobile device. In step 1905, the user scrolls down an selects Chat & Date, as illustrated in FIG. 20, which in turn causes links to one or more dating sites to be displayed. In step 1910, the user selects a dating site that provides a date rating service in accordance with the present invention, as illustrated in FIG. 21. In step 1915, the site provides optional preliminary information, as illustrated in FIG. 22. In step 1920, the user is provided a log-on page. If the user is not yet a member, he or she will, in step 1925, be prompted to sign up and then continue. In step 1930, the user logs on to the Internet dating site, as illustrated in FIG. 23.

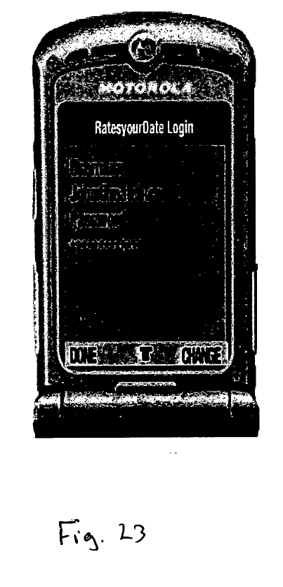

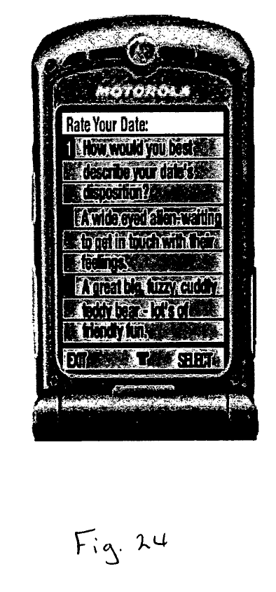

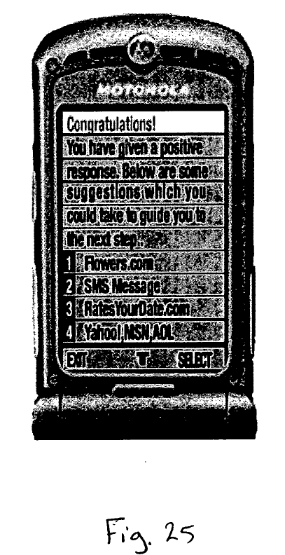

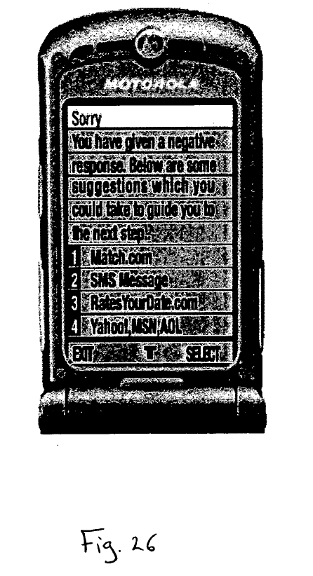

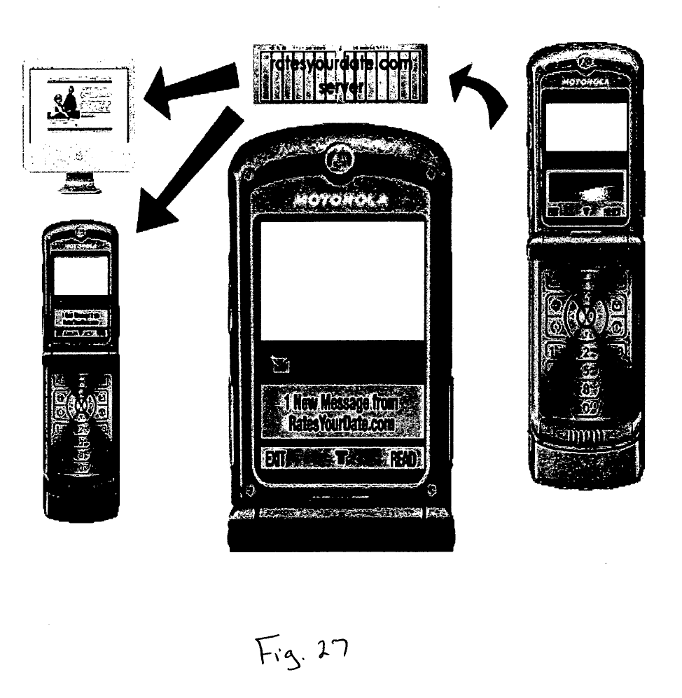

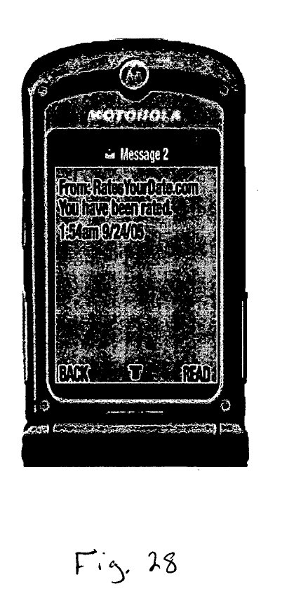

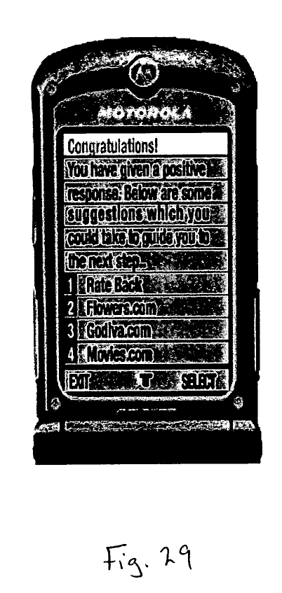

In step 1935, the user's personal page is then displayed and the user may select to complete a date rating. If user selects to complete a date rating, then, in step 1940, the site provides an interactive date questionnaire, a page of which is illustrated in FIG. 24, which the user in turn completes. In step 1945, the site process the questionnaire and assigns a positive or negative rating to it. The site then, in step 1950, prompts the user to take the next step in the dating process. If the rating is positive, the site may prompt the user to, for example, send a gift, such as flowers, or an SMS Message to the other participant in the date, as illustrated in FIG. 25. If the rating is negative, the site may prompt the user to, for example, go to an Internet dating site to continue his or her search for a compatible date, as illustrated in FIG. 26.

In step 1955, the site sends the date rating by, for example, Short Message Service (SMS) and/or email, to the other participant to the date, as illustrated in FIG. 27. In step 1960, the other participant is alerted on his or her mobile device that a rating has been received, as illustrated in FIG. 28. In step 1965, the other participant logs on to the site, as described previously.

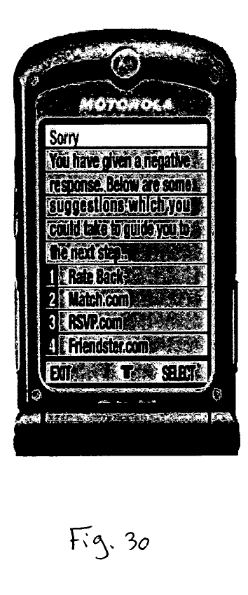

In step 1970, the other participant is prompted to respond to the rating, including an option to rate the user back. If the received rating is positive, the site may prompt the user to send a gift, such as flowers or chocolates, send a message back to the user, provide suggestions for a next date, such as a link to information about current movies, etc., as illustrated in FIG. 29. If the received rating is negative, the site may prompt the user to, for example, go to an Internet dating site to continue his or her search for a compatible date, as illustrated in FIG. 30.

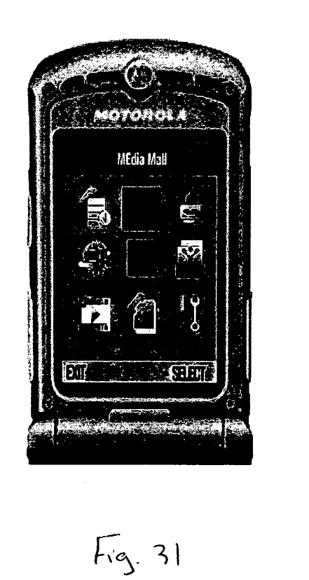

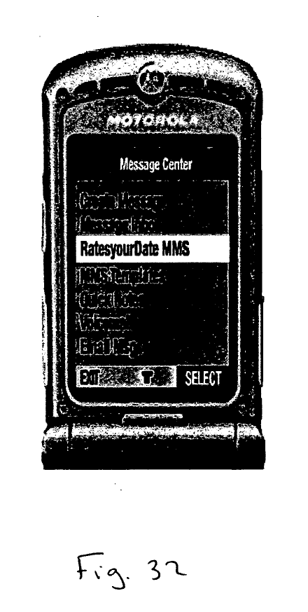

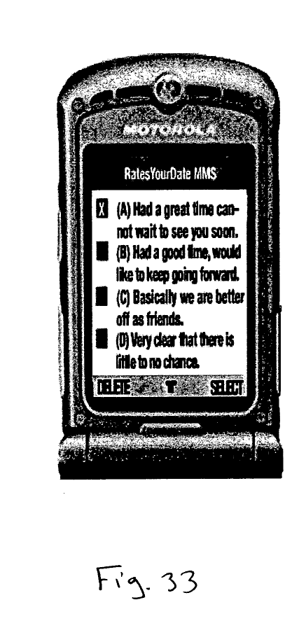

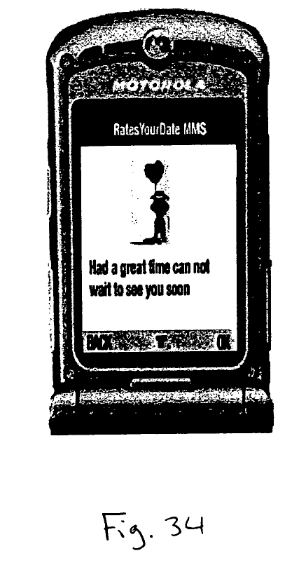

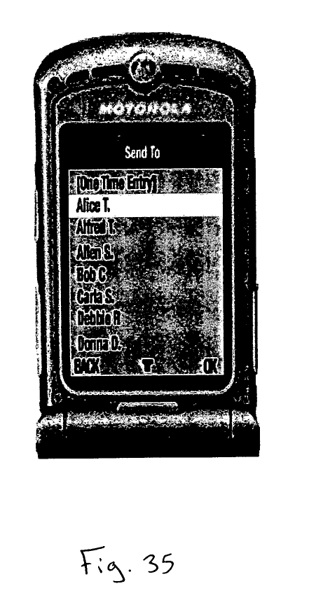

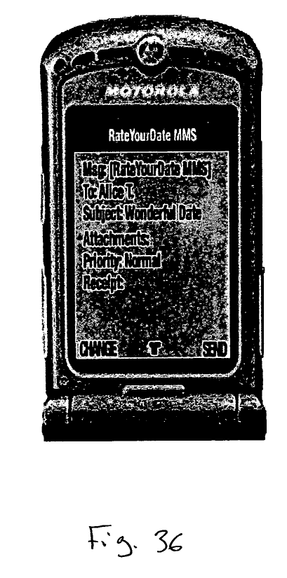

A system in accordance may also provide appropriate pre-written messages to be sent from one date participant to another. As illustrated in FIG. 31, a mail icon can be selected, which in turn displays mail and message related options, as illustrated in FIG. 32. If the date rating MMS menu option is selected (i.e., RatesyourDate MMS in FIG. 32), a number of pre-written messages is displayed, as illustrated in FIG. 33, for selection by the user. The user may also select an animation that will accompany the message, as illustrated in FIG. 34. The user can then either enter the phone number of the other participant or select it from the user's address book, as illustrated in FIG. 35. Lastly the user can add a priority to the message, as illustrated in FIG. 36.

The illustrative descriptions of the application of the principles of the present invention are to enable any person skilled in the art to make or use the disclosed invention. These descriptions are susceptible to numerous modifications and alternative arrangements by those skilled in the art. Such modifications and alternative arrangements are not intended to be outside the scope of the present invention. The appended claims are intended to cover such modifications and arrangements. Thus, the present invention should not be limited to the described illustrative embodiments but, instead, is to be accorded the broadest scope consistent with the principles and novel features disclosed herein.

What is claimed is:

1. A method of processing date information comprising the steps of
providing an on-line questionnaire to a first date participant, wherein the questionnaire comprises questions regarding a date between the first date participant and a second date participant;
receiving responses from the first date participant to the questionnaire; and
automatically sending date information regarding the first date participant's responses to the questionnaire to the second date participant.

2. The method of claim 1 further comprising the step of
determining a date rating based on the responses; and
wherein the step of sending information to the second date participant comprises sending the date rating.

3. The method of claim 2 wherein the date rating is one of a positive rating and a negative rating.

4. The method of claim 1 further comprising the step of sending action prompts to the second date participant, wherein each action prompt is associated with corresponding actions that are automatically initiated if the action prompt is selected by the second date participant.

5. The method of claim 4 wherein the actions initiated by the action prompts are associated with one or more of sending a gift to the first date participant, sending a message to the first date participant, and receiving suggestions for another date.

6. The method of claim 4 wherein the actions initiated by the action prompts are associated with one or more of receiving information regarding dating skills and linking to a dating site.

7. The method of claim 1 wherein the step of sending date information comprises one or more of emailing the information to the second date participant and transmitting a message to the second date participant to be received by a mobile device.

8. The method of claim 1 further comprising the step of
providing action prompts to the first date participant, wherein each action prompt is associated with corresponding actions that are automatically initiated if the action prompt is selected by the first date participant.

9. The method of claim 8 wherein the actions initiated by the action prompts are associated with one or more of sending a gift to the second date participant, sending a message to the second date participant, and receiving suggestions for another date.

10. The method of claim 8 wherein the actions initiated by the action prompts are associated with linking to a dating site.

11. The method of claim 1 wherein
the step of providing an on-line questionnaire comprises sending the questionnaire to a mobile device, and
the step of receiving responses comprises receiving the responses from the mobile device.

12. The method of claim 1 further comprising the step of
providing the date information to interested third parties.

13. The method of claim 1 further comprising the step of
storing the responses to the questionnaire in a database entry associated with the second date participant.

14. The method of claim 13 further comprising the step of
analyzing database entries associated with the second date participant, and
providing improvement information to the second date participant that is useful in addressing the second date participant's dating deficiencies.

15. The method of claim 14 wherein the improvement information comprises one or more of information relating to the second date participant's profile and information relating to the second date participant's picture.

16. A dating system comprising:
means for providing an automated, on-line questionnaire to a first date participant, wherein the questionnaire comprises questions regarding a date between the first date participant and a second date participant;
means for receiving responses from the first date participant to the questionnaire; and
means for automatically sending date information regarding the first date participant's responses to the questionnaire to the second date participant.

17. A dating system comprising:
one or more Internet dating sites; and
a dating evaluation system capable of communicating with the one or more Internet dating sites;
wherein the dating evaluation system stores date evaluation information for one or more users of the one or more Internet dating sites.

18. The system of claim 17 wherein the date evaluation information for a particular user that is a member of more than one Internet dating site is aggregated.

19. The system of claim 17 wherein the one or more Internet dating sites contain a user selectable link to the dating evaluation system.

20. The system of claim 17 wherein features of the dating evaluation system are accessible in a frame displayed by at least one of the one or more Internet dating sites.
